(19) United States
(12) Patent Application Publication
(10) Pub. No.: US 2006/0185736 A1
(43) Pub. Date: Aug. 24, 2006

(54) Two-stage pressure regulator for pressurized gas

(75) Inventor: Savio Cavagna, Ponte San Marco (IT)

Correspondence Address: MODIANO & ASSOCIATI, Via Meravigli, 16, 20123 MILANO, IT

(73) Assignee: CAVAGNA GROUP S.p.A.

(21) Appl. No.: 11/062,576

(22) Filed: Feb. 23, 2005

(51) Int. Cl. G05D 16/06

(52) U.S. Cl. 137/505.12

(57) ABSTRACT

A two-stage pressure regulator for pressurized gas, which comprises a single body that forms a first regulation stage and a second regulation stage, which are connected to each other and are connected respectively to an intake port and a discharge port, further comprising on the single body, a port in which it is possible to provide selectively a first hole connected to the first stage, in order to provide a pressure tap, and a second hole connected to the second stage, in order to provide an additional outlet.

The present invention relates to a two-stage pressure regulator for pressurized gas.

### BACKGROUND OF THE INVENTION

As is known, in many fields of use of liquid and natural gas it is necessary to perform pressure reduction by means of a pressure regulator that has two separate stages arranged in series and connected to each other.

In order to perform two-stage reduction, solutions have already been devised in which in practice there were two separate regulators connected together having however relatively large dimensions and installation complications.

In order to overcome this problem, two-stage pressure regulators have already been devised which have, in a single body, the two mutually connected stages, thus achieving an easy assembly and a significant reduction in external dimensions.

However, with the solutions described above, if the pressure inside the first stage is to be checked, it is necessary to install a pressure sensor, which in the case of two separate bodies constituted an additional component to be added and in the case of a monolithic pressure regulator could not be integrated in the body of the regulator, accordingly requiring specific installations in order to be able to acquire the value of the pressure in the first stage, consequently causing substantial constructive complications.

Moreover, if an additional output is to be provided, it is necessary to modify radically the entire structure.

### SUMMARY OF THE INVENTION

The aim of the invention is to solve the problem described above by providing a two-stage pressure regulator for pressurized gas that allows to alternately check the pressure of the first regulation stage, or provide an additional output, or provide a right-angled output, without thereby having to face production and manufacturing complications.

Within this aim, an object of the invention is to provide a pressure regulator that allows to have a particularly high flow-rate, thus making it very versatile for several kinds of application.

Another object of the present invention is to provide a two-stage pressure regulator that thanks to its particular constructive characteristics is capable of giving the greatest assurances of reliability and safety in use.

Another object of the present invention is to provide a two-stage pressure regulator for pressurized gas that can be easily obtained starting from commonly commercially available elements and materials and is also competitive from a merely economical standpoint.

This aim and these and other objects that will become better apparent hereinafter are achieved by a two-stage pressure regulator for pressurized gas according to the invention, comprising a single body that forms a first regulation stage and a second regulation stage, which are connected to each other and are connected respectively to an intake port and a discharge port, characterized in that it comprises, on said single body, a port in which it is possible to selectively provide a first hole for connection to said first stage, in order to selectively provide a pressure tap, and a second hole for connection to said second stage, in order to provide an additional outlet.

### BRIEF DESCRIPTION OF THE DRAWINGS

Further characteristics and advantages of the invention will become better apparent from the description of a preferred but not exclusive embodiment of a two-stage pressure regulator for pressurized gas, illustrated by way of non-limiting example in the accompanying drawings, wherein:

FIG. 1 is a sectional view of the pressure regulator;

FIG. 2 is a perspective view of the pressure regulator;

FIG. 3 is a schematic plan view of the pressure regulator, taken from the side of the first stage;

FIG. 4 is a partially sectional view of a detail of the venting valve arranged on the second stage;

FIG. 5 is an elevation view of the central body of the pressure regulator;

FIG. 6 is a sectional view, taken along the line VI-VI of FIG. 5, with the provision of a first hole in the port;

FIG. 7 is a sectional view, taken along the line VI-VI of FIG. 5, with the provision of a second hole;

FIG. 8 is a sectional view of a pressure regulator with means for regulating the setting of the second stage.

### DESCRIPTION OF THE PREFERRED EMBODIMENTS

With reference to the figures, the two-stage pressure regulator for pressurized gas according to the invention, generally designated by the reference numeral 1, comprises a single body, which has a central body 2, which forms, by means of a first dome 3 and a second dome 4, a first regulation stage, generally designated by the reference numeral 5, and a second regulation stage, generally designated by the reference numeral 6, which are connected to each other and respectively connected to an intake port 7 and a discharge port 8.

A characteristic of the invention consists in that the two regulation stages 5 and 6 are superimposed and coaxial to each other, so as to provide a pressure regulator that is particularly compact and at the same time particularly reliable.

In a per se known manner, the first stage has a first oscillating lever 10 which, by means of a first gasket 11, controls a first inflow passage 12 that is connected to the intake port 7.

A first membrane 15 acts in a per se known manner on the end of the lever 10 that lies opposite the end provided with the gasket, and is pushed by a first preset spring 16.

The first stage 5 is connected, by means of a second passage 20, to the second regulation stage 6, which is provided with a second lever 21, which has a second gasket 22 that controls the second passage 20.

The second lever 21 acts on a second membrane 23, which is provided with a safety valve of the second stage, which is obtained by means of a disk 24 whereon the membrane 23 is placed, said disk interacting with the flange 25 of a central stem 26, which, if the lever 21 breaks, forms a passage between the disk 24 and the flange 25, thus allowing the gas to exit in the region delimited by the half-shell 4, which is advantageously provided with a venting hole 28, which is optionally provided with a protective mesh 27 that allows the outflow of the gas.

A particular characteristic of the invention consist in that a communication port 30 is provided that can be machined differently in order to obtain a different function.

More specifically, if a pressure tap is to be provided, it is possible to provide a first hole 31, which connects the port 30 to the first stage.

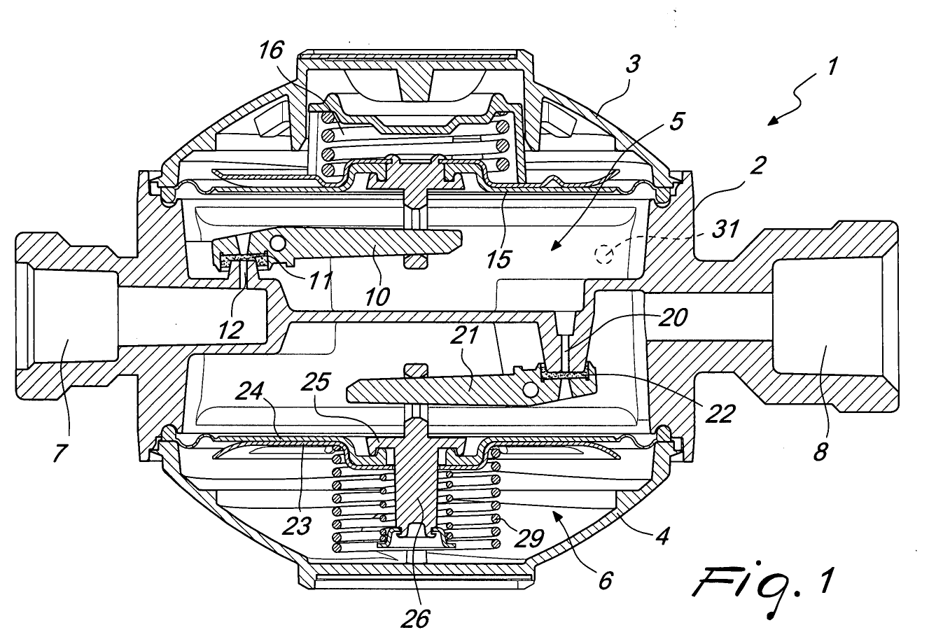

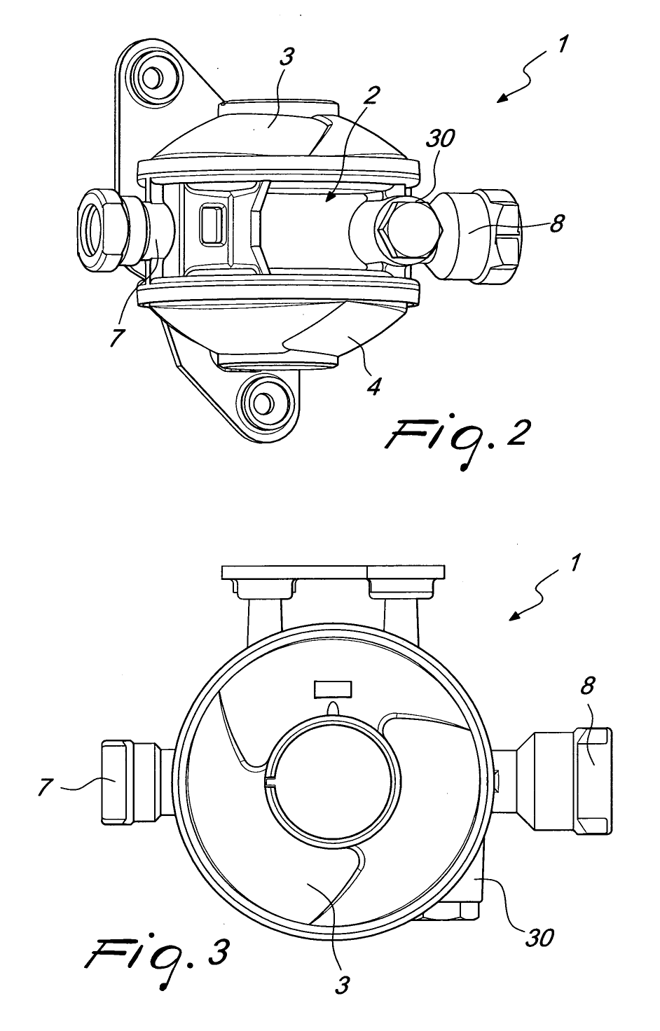

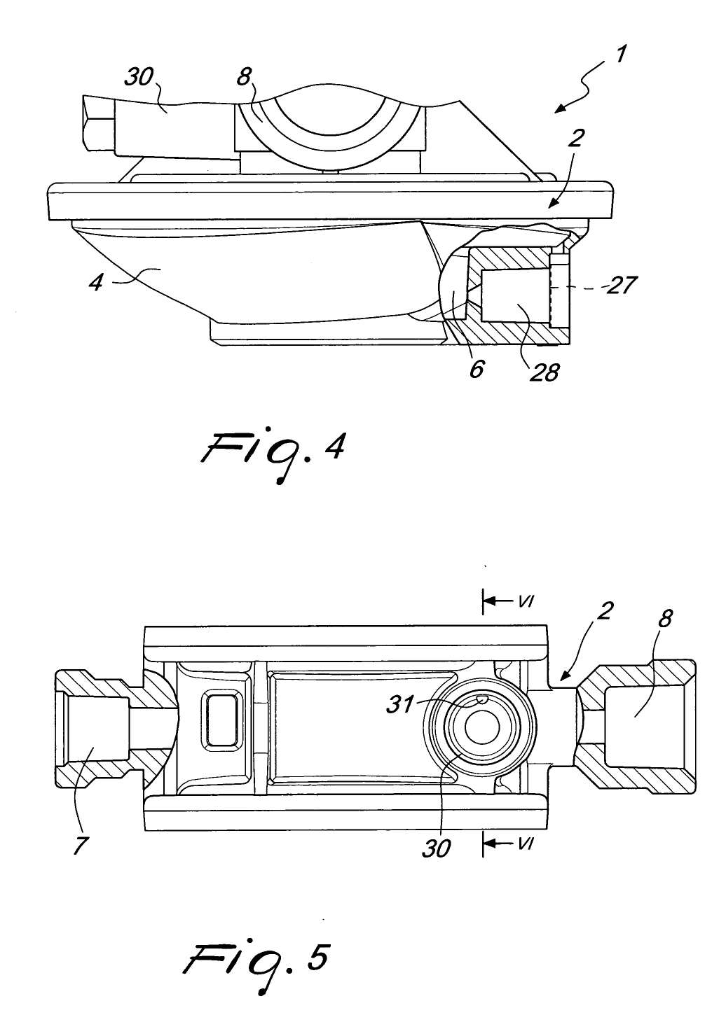

On the bottom of the port 30 there is the first hole 31, which is clearly shown in FIG. 6 and is simply shown in dashed lines in FIG. 1, since the aperture of the hole that leads into the first stage 5 would be arranged on the removed part of the cross-section.

The hole 31 allows to provide directly on the valve body the connecting element with, inside the first stage, a pressure tap, in which it is possible to insert, if required, a pressure gauge or optionally a closure plug.

With this arrangement, it is therefore possible to visualize the pressure inside the first stage without having to resort to the application of separate bodies in order to acquire the pressure.

Moreover, if an additional outlet on the second stage is to be provided, a second hole 32 is provided in the communication port 30 and connects the port 30 to the second stage; it should be noted that the additional outlet can be added to the other existing outlet or it is possible to provide a single outlet at right angles.

The port 30 provided on the central body preferably lies substantially at right angles to the direction of the intake port 7 and the discharge port 8.

It should also be noted that in the arrangement described above it is possible to have a safety valve on the second stage that is integrated directly in a two-stage pressure regulator, which is obtained monolithically so that the two stages are superimposed and coaxial to each other.

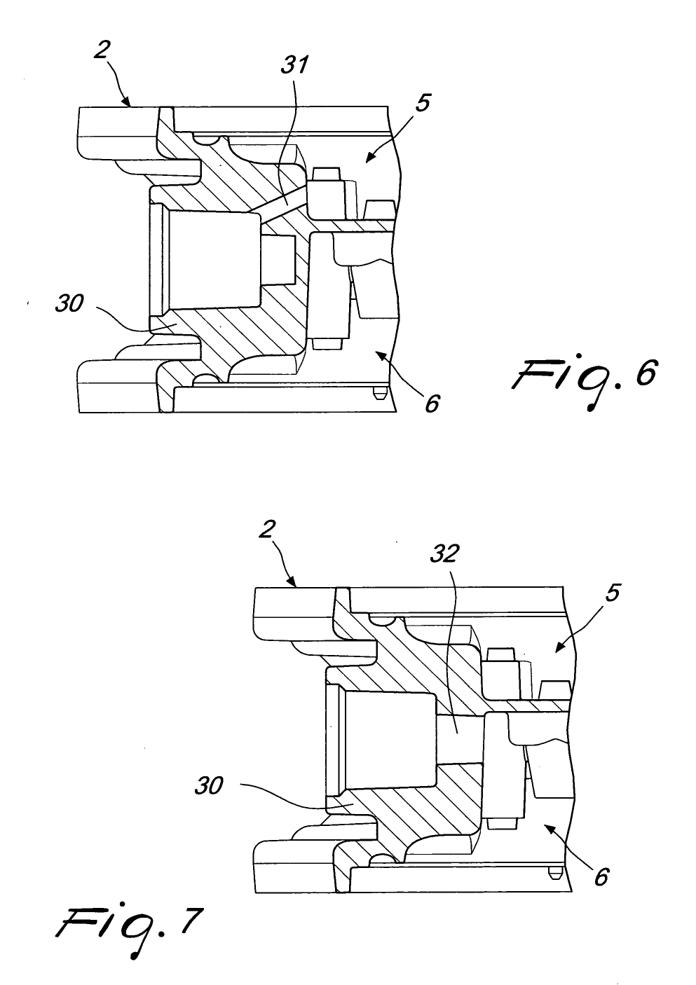

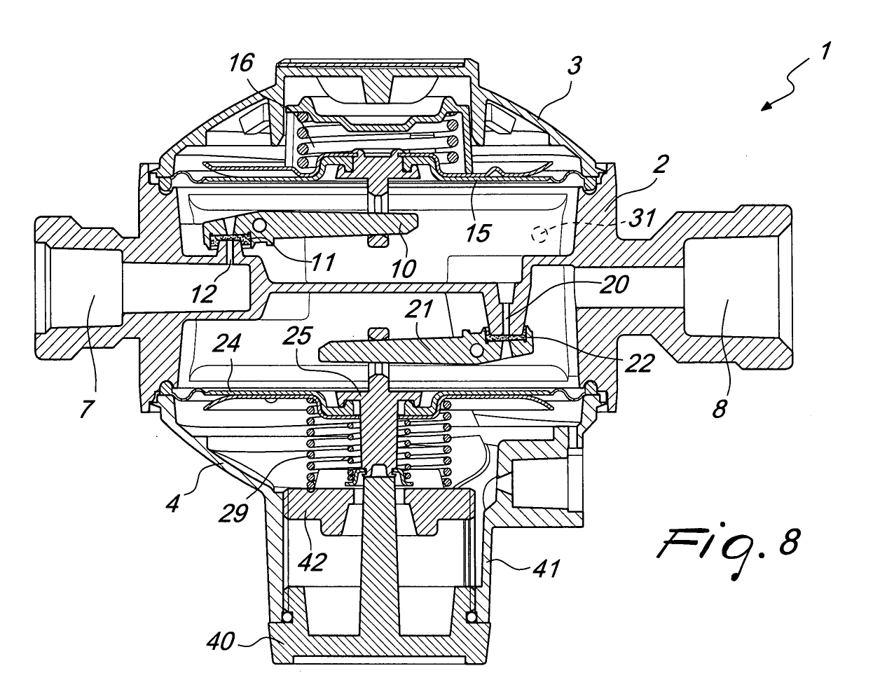

According to what is shown in the embodiment of FIG. 8, the regulator may have, on the second stage, setting adjustment means, obtained schematically by means of a plug element 40, which is arranged on a shank 41 formed by the dome 4 and can be removed so as to allow access to the ring 42, which is threaded at an inner surface of the shank 41 and can rotate so as to vary the setting of the second springs 29 provided in the second stage.

With the arrangement described above, it is possible to integrate the free setting of the second stage in a monolithic two-stage regulator, thus allowing to better adapt to the requirements of the user.

It should be added to the above that the two-stage pressure regulator described above allows to have very high flow-rates and in particular a nominal flow-rate of approximately 160,000 BTU and in any case always higher than 100,000 BTU.

From what has been described above it is therefore evident that the invention achieves the intended aim and objects, and in particular attention is called again to the extreme constructive simplicity and the particular compactness, which allow to have a two-stage regulator with the possibility of acquiring the pressure inside the first stage or of obtaining an additional outlet.

The invention thus conceived is susceptible of numerous modifications and variations, all of which are within the scope of the appended claims.

All the details may further be replaced with other technically equivalent elements.

In practice, the materials used, so long as they are compatible with the specific use, as well as the contingent shapes and dimensions, may be any according to requirements.

What is claimed is:

1. A two-stage pressure regulator for pressurized gas, comprising: a single body that forms a first regulation stage and a second regulation stage, and is provided with an intake port and a discharge port, said first and second regulation stages being connected to each other and connected respectively to said intake and discharge ports; a communication port arranged on said single body and in which it is selectively providable a first hole for connection to said first stage, in order to provide a pressure tap, and a second hole for connection of the communication port to said second stage, in order to provide an additional outlet.

2. The pressure regulator of claim 1, wherein said single body comprises a central body with a first dome and a second dome connected thereto, said first and second domes respectively delimiting said first regulation stage and said second regulation stage.

3. The pressure regulator of claim 1, wherein said first and second regulation stages are superimposed and coaxial to each other.

4. The pressure regulator of claim 2, wherein said pressure tap is formed by said communication port that is provided in said central body and is connected to said first hole that leads into said first regulation stage.

5. The pressure regulator of claim 1, wherein said communication port with said second hole provides said additional outlet in addition to said discharge port.

6. The pressure regulator of claim 1, wherein said communication port with said second hole provides said additional outlet as a single right-angled outlet.

7. The pressure regulator of claim 1, wherein said communication port lies substantially at right angles to said intake port and said discharge port.

8. The pressure regulator of claim 2, comprising a safety valve arranged at said second stage.

9. The pressure regulator of claim 8, comprising a second lever of the second regulation stage, said safety valve comprising a disk with a membrane that delimits said second regulation stage positioned on the disk, a central stem, a flange arranged on said central stem that is adapted to provide, upon breaking of the second lever, a passage between said disk and said flange, and a venting hole for outflow of the gas that is provided on said second dome.

10. The pressure regulator of claim 9, comprising setting adjustment means on said second regulation stage.

11. The pressure regulator of claim 10, comprising second springs that act on the membrane of said second regulation stage; a ring that is mounted at said shank turnable in order to vary setting of the second springs; said setting adjustment means comprising: a shank that is formed by said second dome; and a plug element, which is arranged on said shank so as to be removable for access to said ring.

12. A two-stage pressure regulator for pressurized gas, comprising: a single body that forms a first regulation stage and a second regulation stage, and is provided with an intake port and a discharge port, said first and second regulation stages being connected to each other and connected respectively to said intake and discharge ports; a communication port arranged on said single body and in which it is selectively providable a first hole for connection to said first stage, in order to provide a pressure tap, and a second hole for connection of the communication port to said second stage, in order to provide an additional outlet; and setting adjustment means provided at said second regulation stage.

13. A two-stage pressure regulator for pressurized gas, comprising: a single body that forms a first regulation stage and a second regulation stage, and is provided with an intake port and a discharge port, said first and second regulation stages being connected to each other and connected respectively to said intake and discharge ports; a communication port arranged on said single body and in which it is selectively providable a first hole for connection to said first stage, in order to provide a pressure tap, and a second hole for connection of the communication port to said second stage, in order to provide an additional outlet; and setting adjustment means provided at said second regulation stage, said single body comprising a central body with a first dome and a second dome connected thereto, said first and second domes respectively delimiting said first regulation stage and said second regulation stage, and wherein are provided second springs that act on the membrane of said second regulation stage; a ring that is mounted at said shank turnable in order to vary setting of the second springs; said setting adjustment means comprising: a shank that is formed by said second dome; and a plug element, which is arranged on said shank so as to be removable for access to said ring.
